(19) United States
(12) Patent Application Publication
(10) Pub. No.: US 2013/0065662 A1
(43) Pub. Date: Mar. 14, 2013

(54) SLOT MACHINE GAME WITH BONUS GAME HAVING SELECTABLE MODIFIER ELEMENTS

(71) Applicants: Brian A. Watkins, Austin, TX (US); Clint A. Owen, Austin, TX (US)

(72) Inventors: Brian A. Watkins, Austin, TX (US); Clint A. Owen, Austin, TX (US)

(21) Appl. No.: 13/231,448

(22) Filed: Sep. 13, 2011

(51) Int. Cl. A63F 13/00

(52) U.S. Cl. 463/20

(57) ABSTRACT

A game is provided, including a free spin bonus game with selectable modifier feature, known in a preferred embodiment as a bank heist bonus game. Before each free spin, the player picks a vault to receive a modifier element that applies to the free spin. The modifier element may be a credit prize, increment bonus multiplier, award additional spins, or turn a random reel wild (may be maintained wild for all remaining free spins or a designated number of free spins), for example. Additional spins can also be retriggered on the reels up to a maximum of 20 free spins (get all the vaults). To begin the free spin bonus game, the game may prompt the player for some type of biometric input and either read or appear to read biometric data as part of the game theme.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all rights.

### TECHNICAL FIELD OF THE INVENTION

The invention relates to gaming machines and systems, wherein the players participate in wagering games. More particularly, the invention relates to methods for conducting an interactive reel or symbol array type wagering games.

### BACKGROUND OF THE INVENTION

Various slot machine games use player selectable elements or other interactive features to enhance the game experience for games with reels, simulated reels, or other arrays of gaming symbols. Some games use free spin rounds including one or more free spins to increase excitement by providing extra opportunities for play along with an enhanced set prizes. This is typically referred to as a free spin bonus round. Although free spin bonuses are entertaining, they may eventually leave the player feeling like a drone as their only input is starting a spin. What is needed is a free spin bonus that provides more player interaction, leaving the player with a feeling of control.

### SUMMARY OF THE INVENTION

The present invention includes a highly entertaining method of conducting a game for one or more players. The entertainment value is achieved partially by a reel symbol game including a free spin bonus game with selectable modifier feature, known in a preferred embodiment as a bank heist bonus game. Before each free spin in the bonus game, the player picks a vault to receive a modifier element that applies to the free spin. The modifier element may be a credit prize, increment bonus multiplier, award additional spins, or turn a random reel wild (which may be wild for one spin or stay wild for all remaining free spins in various embodiments), for example. Additional spins can also be retriggered on the reels up to a maximum of 20 free spins, which get all of the available vaults. To begin the free spin bonus game, the game may prompt the player for some type of the biometric input and either read or appear to read biometric data as part of the game theme.

Another version of the invention is a computer program stored on a non-transitory readable medium. The software version is, of course, typically designed to be executed by a gaming machine or networked gaming system. The software includes multiple portions of computer executable code referred to as program code. Gaming results are provided in response to a wager and displayed by display program code that generates simulated slot reels each including one or more symbol locations. The program also has game controller program code for determining game play results involving spins or other randomization of an array of symbols, and providing the selectable bonus modifier elements in the bonus round.

Another version of the invention is a gaming system that includes one or more gaming servers, and a group of electronic gaming machines connected to the servers by a network. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. For example, different animation themes may be applied that display the application of the bank heist bonus field in different ways.

These and other advantages and features of the invention will be apparent from the following description of the preferred embodiments, considered along with the accompanying drawings.

### BRIEF DESCRIPTION OF THE DRAWINGS

FIG. 1A is a representation of a graphic display of a game screen example according to one embodiment of the invention.

FIG. 1B is a representation of a graphic display of a bonus game screen example according to one embodiment of the invention.

FIG. 1C is an example of artwork that may be used according to one embodiment of the invention.

FIG. 1D is a base game screen diagram showing a free spin scatter pattern that may be used according to one embodiment of the invention.

FIG. 1E is a bonus game screen diagram that may be used according to one embodiment of the invention.

FIG. 2A is a flowchart showing an example of the general game play process at a gaming machine that includes the bank heist bonus sequence.

FIG. 2B is a flowchart showing an example of the bank heist bonus round logic according to one embodiment of the invention.

FIG. 2C is a flowchart showing an example of a Class II version of the bank heist bonus logic according to one embodiment of the invention.

FIG. 2D is an example of a possible game play sequence according to one embodiment of the invention.

FIG. 3A is a front perspective view of a gaming machine which may be used in a gaming system embodying the principles of the present invention.

FIG. 3B is a block diagram showing various electronic components of the gaming machine shown in FIG. 3A together with additional gaming system components.

FIG. 4A is a system block diagram of a gaming system according to one embodiment of the present invention.

FIG. 4B is a system block diagram of a gaming system according to another embodiment.

### DETAILED DESCRIPTION OF PREFERRED EMBODIMENTS

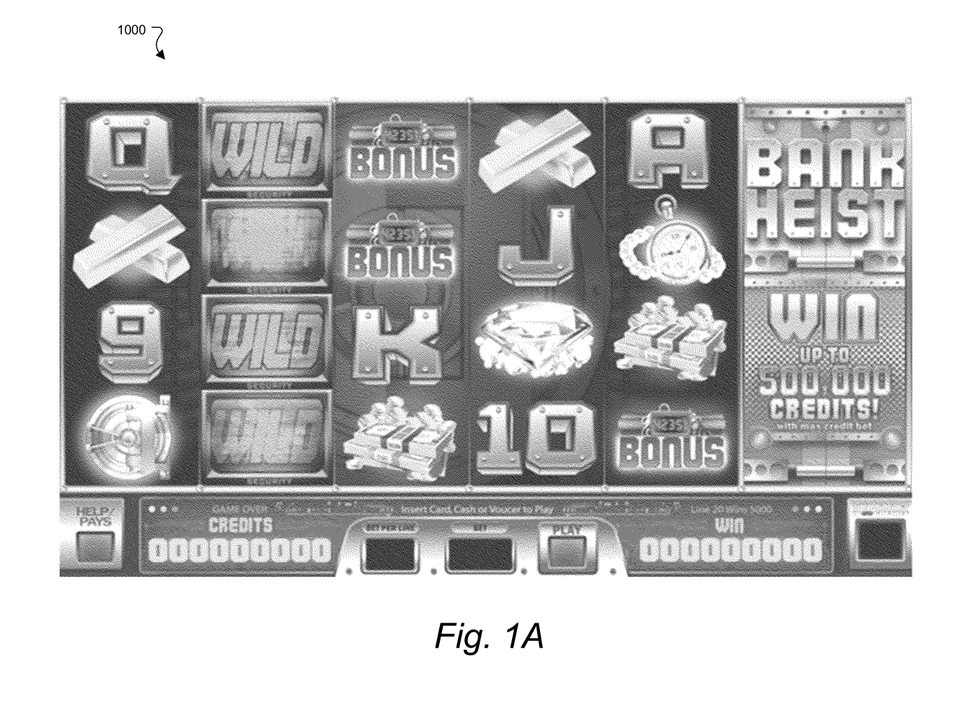

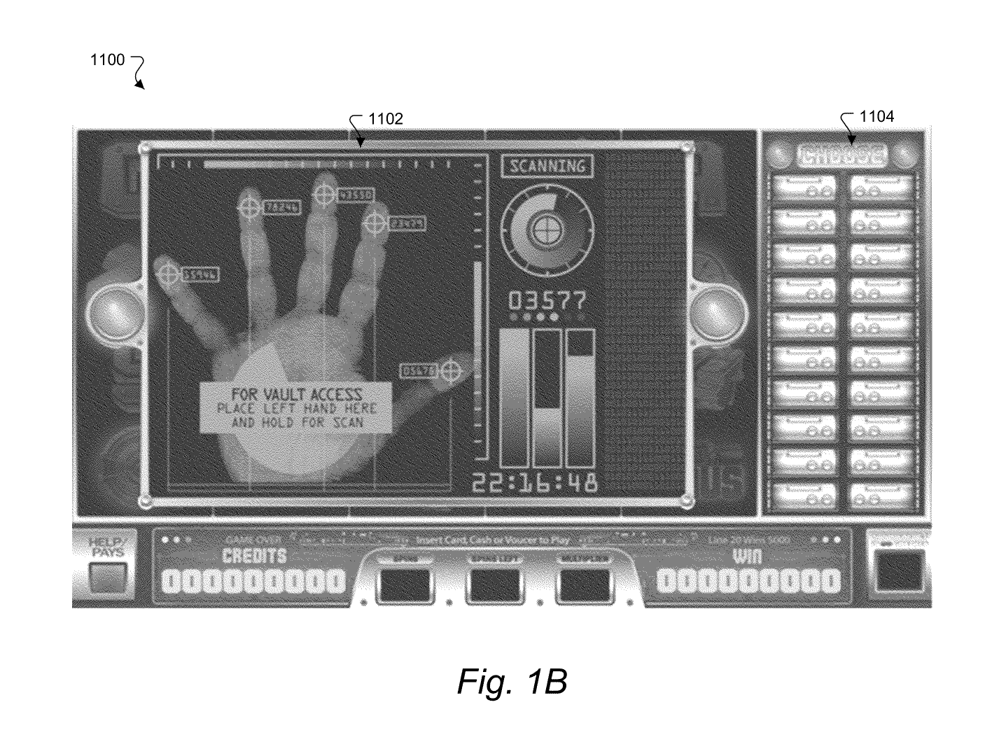

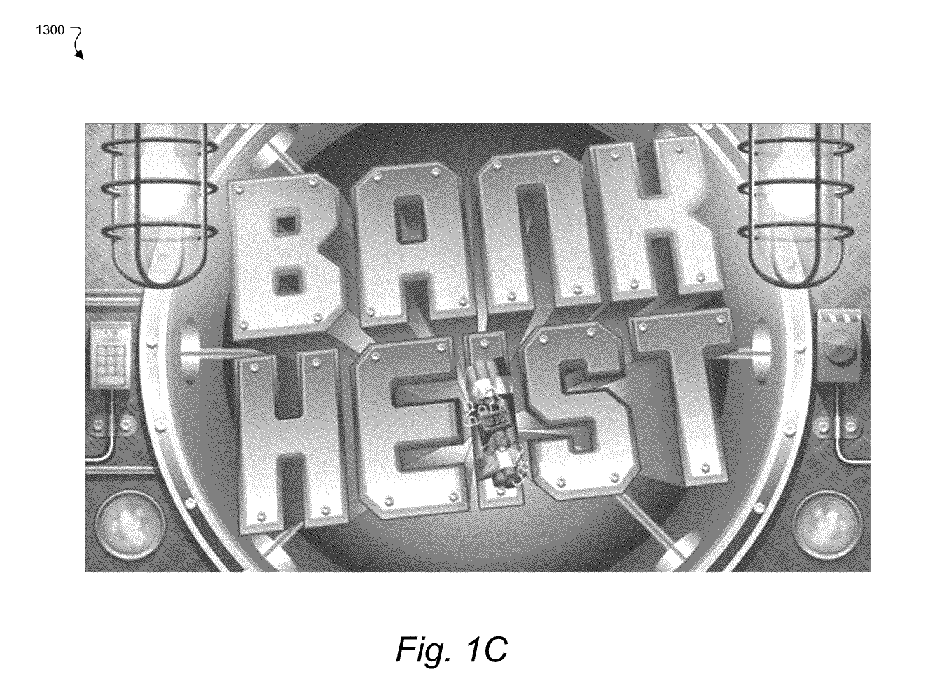

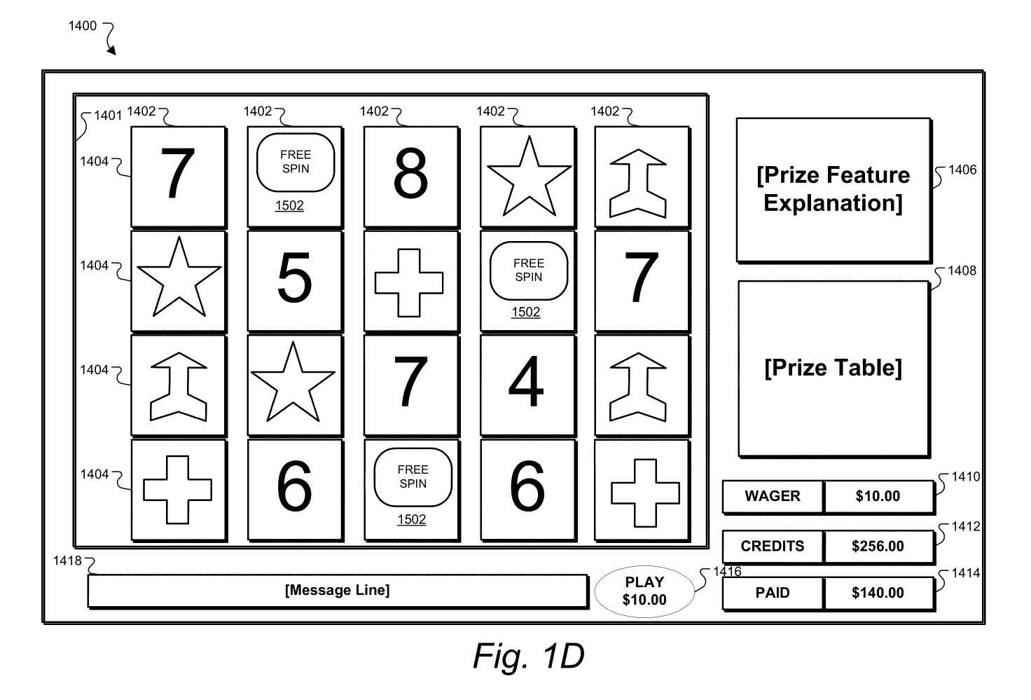

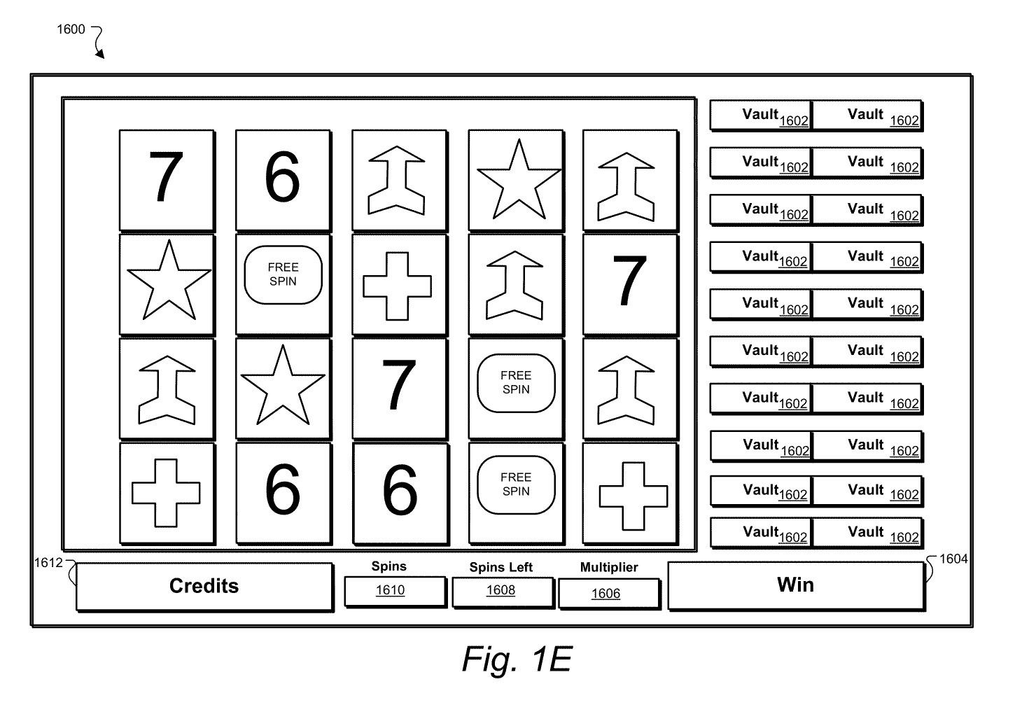

FIG. 1A is a representation graphic display of an example game screen 1000 according to an embodiment of the invention. In this representation, game screen 1000 is shown before the player has placed a wager or started a game. Functionality provided with this game screen will be discussed with regard to the diagram of FIG. 1D.

FIG. 1B is an example of a graphic display of a bonus game screen 1100 according to one embodiment of the invention. This embodiment includes a biometric player interaction feature 1102, which prompts the player for a biometric input, in this case placing their hand on the screen for supposed scanning When the presence of a hand is detected on the touchscreen, the screen displays a faux scanning sequence and pretends that the biometric input has been approved, employing this player interaction in a step in the game such as access to a bank vault area. Bonus game screen 1100 also includes a number of selectable bonus spin modifiers 1104 (“bonus modifiers”, “modifier elements”) which are employed as further described below to modify a free spin bonus game.

FIG. 1C is an example of artwork that may be used in one embodiment of the invention. In this example, artwork 1300 may be used at the top of a wagering machine to attract potential players.

FIG. 1D is an example game screen diagram showing a base game screen according to one embodiment. In this example embodiment, game screen 1400 has a matrix of symbol locations 1401. The matrix of symbol locations 1401 consists of five reels 1402, and each reel has four positions 1404. In this example, the player has already placed a wager, and started a wagering game. In this game screen diagram 1400, three free spin symbols 1502 have been revealed. In a preferred embodiment, the player receives a free spin bonus round including the techniques herein and a number of free spins determined by the number of free spin symbols in the scatter pattern activating the bonus round. A preferred version gives four free spins for three free spin symbols, seven free spins for four free spin symbols, and ten free spins for five free spin symbols. Other versions may of course provide other schemes such as 4/6/9 free spins for 3/4/5 symbols respectively, or any other designated set including more than one amount of free spins each associated with a respective designated pattern. In this example, the player only has three free spin symbols 1502, so the player only receives four free spins.

Referring to the other items in the depicted example screenshot, next to the matrix of symbol locations 1401 there is an area that has a prize feature explanation 1406. Under the prize feature explanation 1406 there is a prize table 1408. Under the prize table 1408 are found the current wager 1410, available credits 1412, and the payout 1414. Along the bottom of the game screen 1400 there is a message line 1418, and a listing of the minimum wager 1416.

FIG. 1E shows a bonus game screen diagram 1600 according to one embodiment of the invention. This bonus screen is displayed when the player has received free spins. In a preferred embodiment, the player would then select a vault 1602 to open for the next free spin. Bank vaults may be opened to reveal credit prizes, increment bonus multipliers, award extra spins, or apply a random reel designated as all wild symbols for all of the remaining free spins or a designated number of free spins less than the number remaining Along the bottom of the screen there is a counter for the total spins 1610, spins left 1608, and multiplier 1606. On the left of the counters is a display with the player's current credits 1612 and on the right of the counters is a display 1604 with the player's current winnings

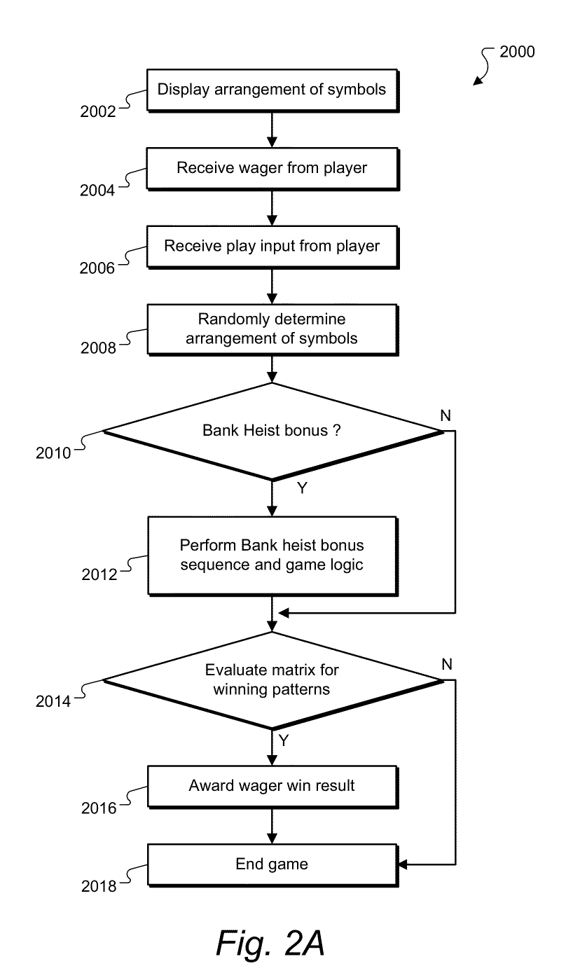

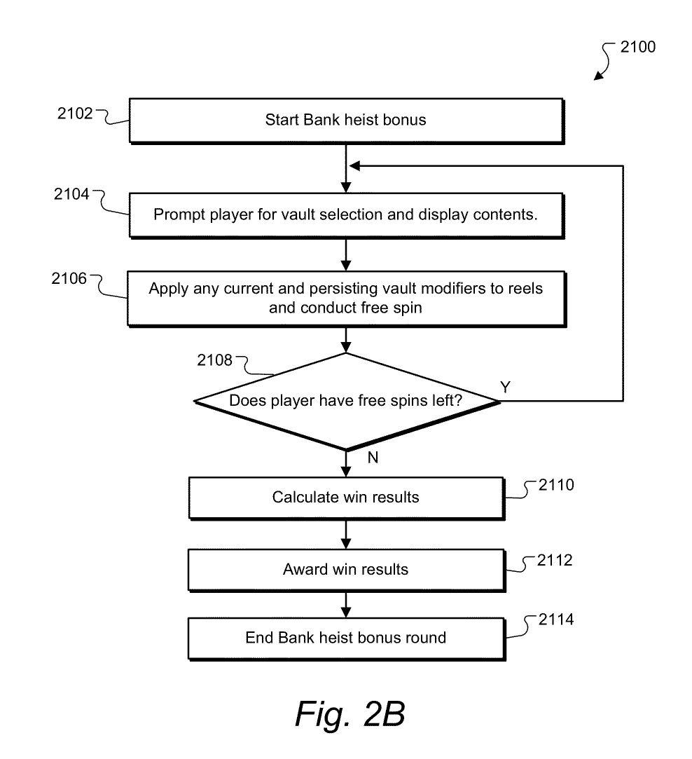

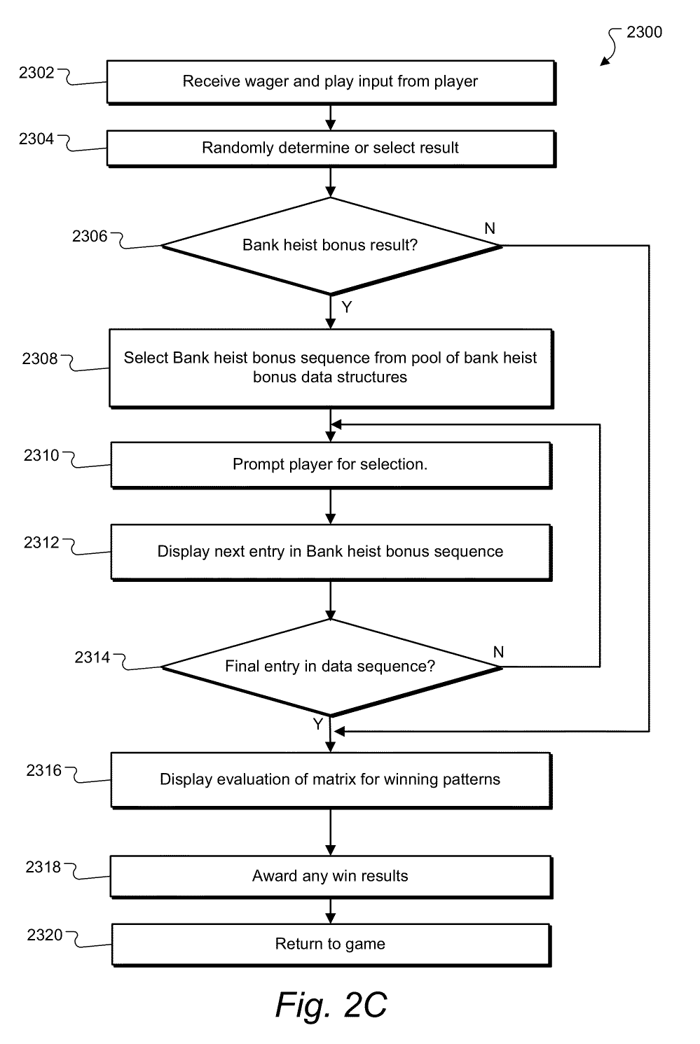

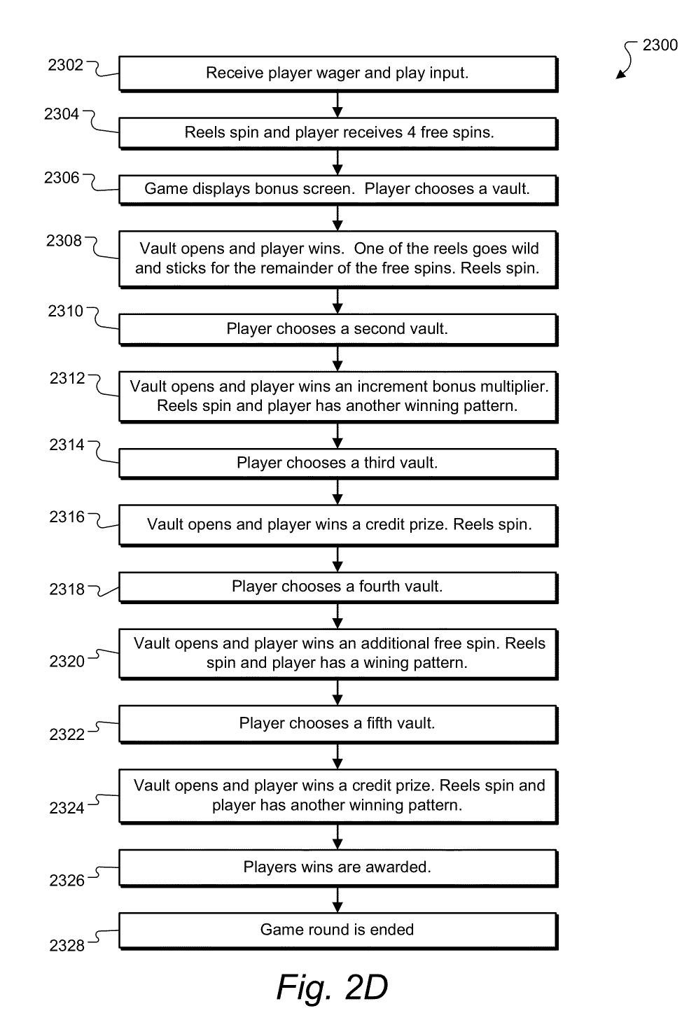

FIG. 2A is a flowchart of a game play example embodiment of the bank heist game. This flowchart 2000 includes the bank heist bonus process. The process starts in step 2002 where the game displays an arrangement of symbols on the game screen. This is known as an attract screen, and may feature different graphical displays of the various features of the game. Next, the process in step 2004 receives a wager from the player, and then receives a play input from the player is step 2006.

After receiving the play input in step 2006, the process then in step 2008 randomly determines the symbol content of the reels (matrix of symbol locations) and populates them with the selected symbols to display the game result. Although in this embodiment, the process only now determines the content of the reels, in other possible embodiments, the content of the reels may be determined at different steps. For example, a Class II bingo type pre-generated system may be used, and the contents of the game may be generated before the player even approaches the gaming machine.

Next, at step 2010, the process evaluates the contents for the presence of a free spin scatter pattern which in this embodiment is referred to as the Bank Heist bonus. In a preferred embodiment, the player would receive four free spins for three free spin symbols, seven free spins for four free spin symbols, and ten free spins for the presence of five free spin symbols, but other possibilities include letting the player receive a free spin for each free spin symbol. If the process has determined that there are one or more free spins at this step, then the process moves to step 2012 and performs the bank heist bonus sequence and game logic. After the bank heist bonus sequence, the process then goes to step 2014 where it evaluates the reels for any winning patterns. If in step 2010 the process does not activate the bank heist bonus, then the process goes directly to step 2014 to evaluate the reels for winning patterns. If there are winning patterns, then the process awards them in step 2016 before ending the game in step 2018. If there are no winning patterns, the process ends the game in step 2018.

FIG. 2B is a flowchart showing an example embodiment of the bank heist bonus logic. In this embodiment, the process starts flow chart 2100 at step 2102 where the bank heist bonus game has already been activated. The process goes to step 2104, where it prompts the player and receives a vault selection. In a preferred embodiment, the prizes in the vaults include credit prizes, increment bonus multiplier, additional free spins, or a reel turned wild for the remainder of the free spins. Other embodiments may have a different prize listing that may or may not include the previous prizes. Then in step 2106, the process causes the reels to spin, and then determines if the player has a winning pattern, taking into account any effect on the spin result from the modifier element chosen for the current free spin, and also any modifier elements that persist from previous free spins according to their respective properties. The process then goes to step 2108 and evaluates whether the player has any free spins left.

If the process determines that there are free spins left in step 2108, then the process returns to step 2104 and prompts the player to select another vault. If, however, the process finds no remaining free spins in steps in step 2108, then the process moves to step 2110 where it calculates the win results, then to step 2112 where it awards the win results, and finally to step 2114 where it would conclude the bank heist bonus round. Some embodiments show the award of credits to the player's credit total after each free spin rather than adding the entire bonus credit win to the player's total as a separate step at steps 2110 and 2112.

FIG. 2C is an example embodiment of a Class II type game play process for the bank heist bonus game. Class II game systems, such as bingo or electronic lotto are advantageous in certain gaming jurisdictions where they are operable with reduced regulatory and tax requirements. This embodiment uses a Class II bingo game engine to produce outcomes and selects a scripted game presentation that matches the predetermined outcome.

The process begins on the flowchart 2300 at step 2302 where the process receives a wager and a play input from the player. Then is step 2304 the process randomly determines or selects a result. This step may include entering a bingo card specific for the game play into a server based bingo game, or selecting a predetermined electronic lottery ticket record from a group of ticket records, or other suitable Class II result determination method. Next in step 2306 the process determines whether the result will include a bank heist bonus. If it determines that a bank heist bonus result is called for, then in step 2308 the process selects a bank heist bonus sequence from a pool of bank heist bonus sequence data structures. Although this embodiment selects a bank heist bonus sequence at this step, the selection can be made at other locations in the process. For example, the selection can be made right after the process receives the wager and play input from the player in step 2302. As mentioned, the process selects a bank heist bonus sequence in step 2308. The selection is made by matching a bank heist bonus sequence wager value to the previously generated or selected wager value result. The bank heist bonus sequence will include the award value, any expansions, any bonuses, and the symbols to fill in the matrix of symbol locations. Next, the process prompts the player for a vault selection in step 2310. After the player vault selection, the process displays the next entry in the bank heist bonus sequence in step 2312. Then in step 2314, the process evaluates whether the last entry in the bank heist data sequence is the final entry. If it is not the final entry the process returns to step 2310 where it prompts the player for another vault selection. If the process encounters the final entry in the bank heist bonus sequence in step 2314, then the process displays an evaluation of any winning patterns in step 2316, award any wins in step 2318, and returns to the base game in step 2320.

If the process had not encountered a bank heist bonus result in step 2306, then it would have gone directly to step 2316, and displayed any winning patterns, and to step 2318 to award any win results, and finally to step 2320 where it would return to the base game.

FIG. 2D is an example of a game play scenario of the bank heist bonus sequence according to one embodiment of the invention. This sequence is merely one instance of the bank heist bonus game, which illustrates the various features of the invention. Actual game results are of course determined by random processes. The scenario begins in step 2302 where the gaming machine receives a wager and a play input from the player. Next in step 2304, the game machine spins the reels and the player wins a scatter pattern. The player has three free spin symbols that entitle him to four free spins. The gaming machine now displays the free spin bonus screen including the selectable modifier elements (bank vaults) and prompts the player for a vault selection in step 2306. In step 2308, the vault opens to reveal a wild reel modifier that causes one of the reels to be all wild symbols for the remaining free spins. The reels spin again, and the player wins a pattern including at least one symbol on the all-wild reel.

The player now chooses a second vault in step 2310. In step 2312 the vault opens and the player receives an increment bonus multiplier. The reels spin again, and the player wins again, this time having the prize multiplied according to the increment bonus multiplier. Next in step 2314, the player chooses a third vault revealing a credit prize, and in step 2316 the reels spin and no winning patterns are formed, but the player receives the revealed credit prize nonetheless. Now the player chooses a fourth vault for his last free spin in step 2318. The vault opens and the player wins another free spin. The reels spin and in step 2320 the player wins. The player excitedly selects a fifth vault in step 2322 for the extra free spin won in the previous round, and in step 2324 the reels spin and the player wins another credit prize. For all five free spins, the wild reel modifier selected in the first free spin was applied, and for the last four of the five free spins, the increment bonus multiplier modifier selected in the second free spin was applied. Other embodiments may of course apply the persistent wild reel modifier for a designated number of the remaining free spins, such as one, two, or three, rather than all remaining free spins. When the player has no free spins left, the gaming machine totals his wins and awards them in step 2326 before ending the game in step 2328.

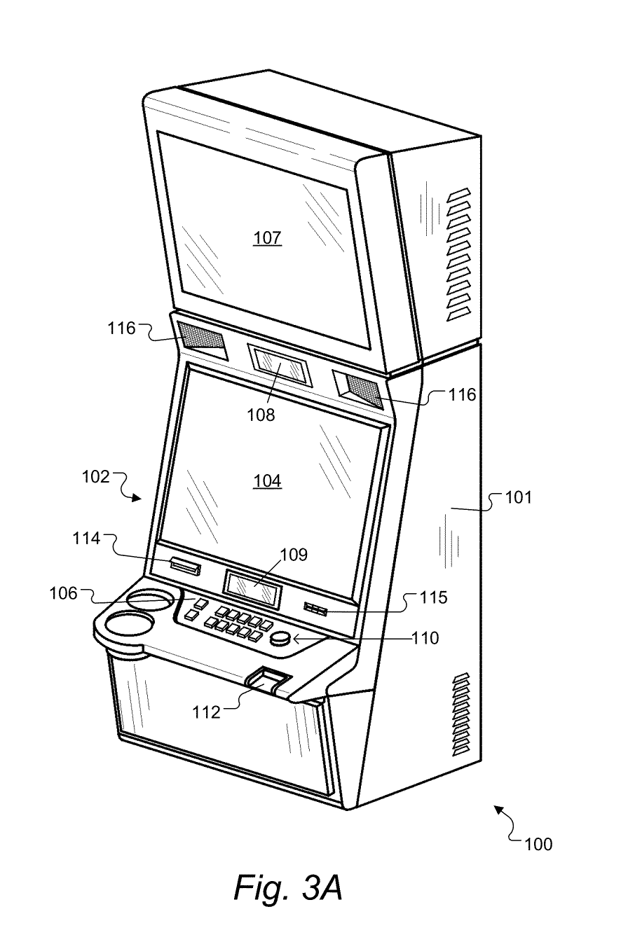

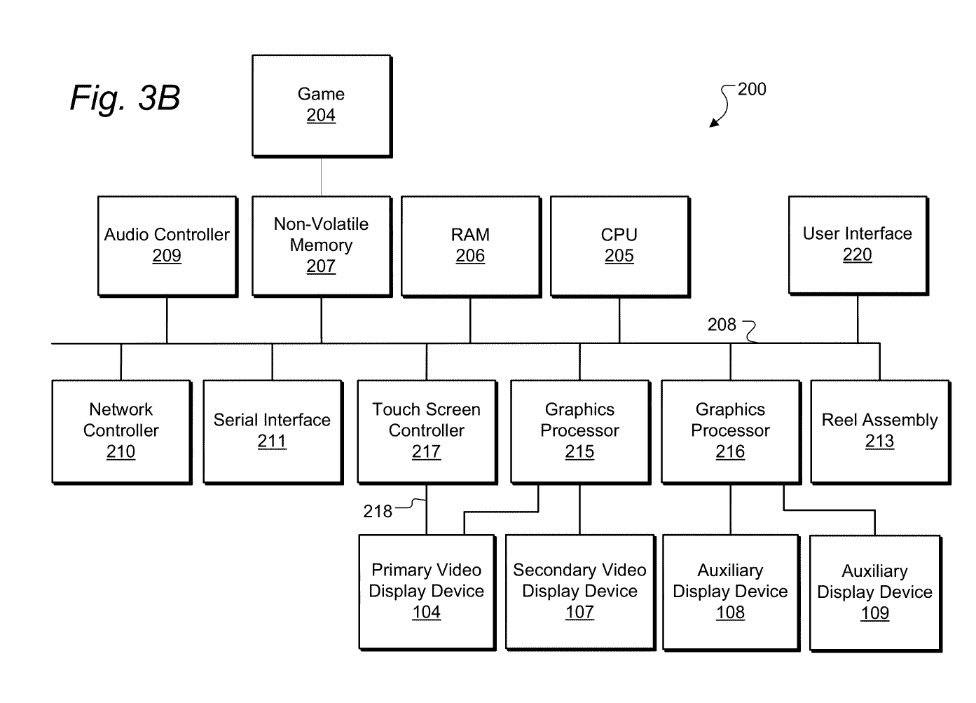

FIG. 3A shows a gaming machine 100 that may be used to implement a bank heist bonus game according to the present invention. The block diagram of FIG. 3B shows further details of gaming machine 100. Referring to FIG. 3A, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 3A also includes a number of mechanical control buttons 110 mounted on ledge 106. These control buttons 110 may allow a player to select a bet level, select paylines, select a type of game or game feature, and actually start a play in a primary game. Other forms of gaming machines according to the invention may include switches, joysticks, or other mechanical input devices, and/or virtual buttons and other controls implemented on a suitable touchscreen video display. For example, primary video display device 104 in gaming machine 100 provides a convenient display device for implementing touchscreen controls.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Audio speakers 116 generate an audio output to enhance the user's playing experience. Numerous other types of devices may be included in gaming machines that may be used according to the present invention.

FIG. 3B shows a logical and hardware block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on bus 208 and is connected to drive primary video display device 104 and secondary video display device 107 (both mounted on cabinet 101 as shown in FIG. 3A). A second graphics processor 216 is also connected on bus 208 in this example to drive the auxiliary display devices 108 and 109 also shown in FIG. 3A. As shown in FIG. 3B, gaming machine 100 also includes a touch screen controller 217 connected to system bus 208. Touch screen controller 217 is also connected via signal path 218 to receive signals from a touchscreen element associated with primary video display device 104. It will be appreciated that the touchscreen element itself typically comprises a thin film that is secured over the display surface of primary video display device 104. The touchscreen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 3B are elements commonly associated with a personal computer. These elements are preferably mounted on a standard personal computer chassis and housed in a standard personal computer housing which is itself mounted in cabinet 101 shown in FIG. 3A. Alternatively, the various electronic components may be mounted on one or more circuit boards housed within cabinet 101 without a separate enclosure such as those found in personal computers. Those familiar with data processing systems and the various data processing elements shown in FIG. 3B will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 3B as being connected directly on system bus 208 may in fact communicate with the other system components through a suitable expansion bus. Audio controller 209, for example, may be connected to the system via a PCI bus. System bus 208 is shown in FIG. 3B merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, it will be appreciated that CPU 205 may control all of the display devices directly without any intermediate graphics processor. In some embodiments, the bank heist vault graphics may be displayed on secondary video display 107 rather than beside the array of selectable game pieces on the primary display. The invention is not limited to any particular arrangement of processing devices for controlling the video display device included with gaming machine 100. Also, a gaming machine implementing the present invention is not limited to any particular number of video display device or other types of display devices.

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game that may be available through the gaming machine, and may also implement a game client for directing one or more display devices at the gaming machine to display portions of a bank heist bonus game according to the present invention. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included. In particular, network controller 210 provides an interface to a game controller which controls certain aspects of the bank heist bonus game as will be discussed below in connection with FIG. 3A.

It should be noted that the invention is not limited to gaming machines employing the personal computer-type arrangement of processing devices and interfaces shown in example gaming machine 100. Other gaming machines through which a bank heist bonus game is implemented may include one or more special purpose processing devices to perform the various processing steps for implementing the present invention. Unlike general purpose processing devices such as CPU 205, these special purpose processing devices may not employ operational program code to direct the various processing steps.

It should also be noted that the invention is not limited to gaming machines including only video display devices for conveying results. It is possible to implement a bank heist bonus game within the scope of the present invention using an electro mechanical arrangement or even a purely mechanical arrangement for displaying the symbols needed to complete the bank heist bonus game as described herein. However, the most preferred forms of the invention utilize one or more video display devices for displaying the spinning reels and the selectable modifier elements. For example, a gaming machine suitable for providing a bank heist bonus game may include a mechanical reel-type display rather than a video-type display device for displaying results in a primary game, and include a video display device for presenting the bank heist bonus game separately.

Still referring to the hardware and logical block diagram 200 showing an example design for a gaming machine 100, the depicted machine in operation is controlled generally by CPU 205 which stores operating programs and data in memory 207 with wagering game 204, user interface 220, network controller 210, audio/visual controllers, and reel assembly 213 (if mechanical reel configuration). CPU or game processor 205 may comprise a conventional microprocessor, such as an Intel Pentium microprocessor, mounted on a printed circuit board with supporting ports, drivers, memory, software, and firmware to communicate with and control gaming machine operations, such as through the execution of coding stored in memory 207 including one or more wagering games 204. Game processor 205 connects to user interface 220 such that a player may enter input information, and game processor 205 may respond according to its programming, such as to apply a wager and initiate execution of a game.

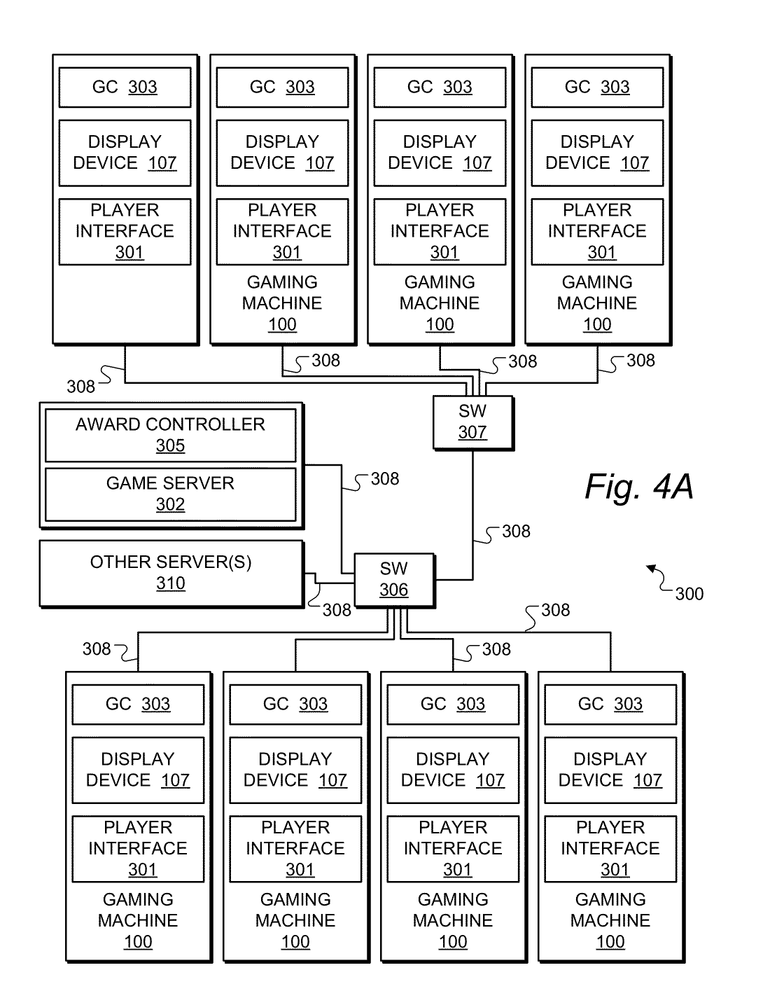

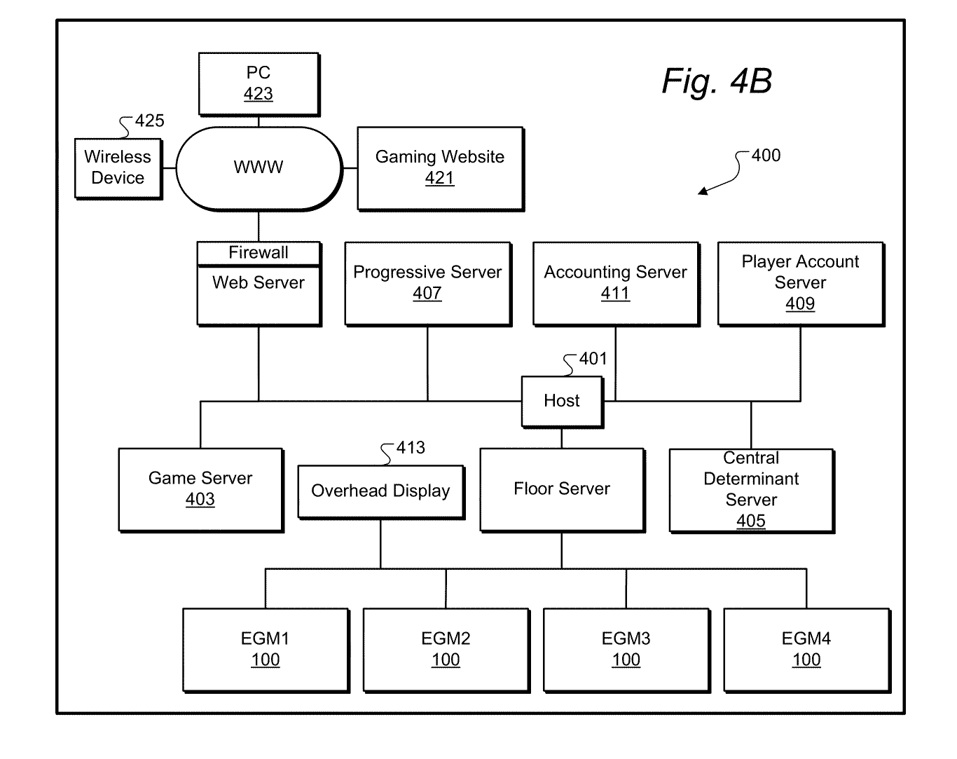

Game processor 205 also may connect through network controller 210 to a gaming network, such as example casino server network 400 shown in FIG. 4B. Referring now to FIG. 4B, the casino server network 400 may be implemented over one or more site locations and include host server 401, remote game play server 403 (which may be configured to provide game processor functionality including determining game outcomes and providing audio/visual instructions to a remote gaming device), central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards.

Referring now to FIG. 4A, a gaming system 300 according to another embodiment of the present invention is shown again in a network and system diagram format. System 300 includes a number of gaming machines, each comprising a gaming machine 100 in this example implementation. For purposes of describing system 300, each gaming machine 100 in FIG. 4A is shown as including a video display device 107 and a player interface that may include buttons, switches, or other physical controls and/or touchscreen controls as discussed above in connection with FIG. 4A. This player interface is labeled 301 in FIG. 4A. System 300 further includes a game server 302 and a respective game client 303 (abbreviated “GC” in FIG. 4A) included with each respective gaming machine 100. In the form of the invention shown in FIG. 4A, these two components, game server 302 and the game client components 303, combine to implement a game control arrangement which will be described in detail below. System 300 also includes an award controller 305, which is shown in FIG. 4A as being associated with game server 302 to indicate that the two components may be implemented through a common data processing device/computer system. Gaming machines 100, game server 302, and award controller 305 are connected in a network communication arrangement including first and second network switches 306 and 307, connected together through various wired or wireless signal paths, all shown as communications links 308 in FIG. 4A.

Each gaming machine 100, and particularly player interface 301 associated with each gaming machine, allows a player to make any inputs that may be required to make the respective gaming machine eligible for a bank heist bonus game, and make selections of any selectable objects displayed at the respective gaming machine in the course of the bank heist bonus game. Player interface 301 also allows a player at the gaming machine to initiate plays in a primary game available through the gaming machine in some implementations. The respective video display device 107 associated with each respective gaming machine 100 is used according to the invention to generate the graphic displays to show the various elements of a bank heist bonus game at the respective gaming machine.

The game control arrangement made up of game server 302 and the respective game client 303 at a given gaming machine functions to control the respective video display device 107 for that gaming machine to display a number of selectable modifier objects. Award controller 305 is responsible for awarding prizes for a player's participation in a bank heist bonus game, and maintaining progressive prize information where the bank heist bonus game offers one or more progressive prizes. The network arrangement made up of network switches 306 and 307, and the various communication links 308 shown in FIG. 4A is illustrated merely as an example of a suitable communications arrangement. It should be noted that the game control arrangement, or as it is referred to generally the “game controller,” may be implemented in some embodiments entirely on the gaming machine. This is especially true in jurisdictions that allow Class III gaming conducted with random number generators at each gaming machine. The present invention is not limited to any particular communications arrangement for facilitating communications between game server 302 and various gaming machines 100. Any wired or wireless communication arrangement employing any suitable communications protocols (such as TCP/IP for example) may be used in an apparatus according to the invention.

FIG. 4A shows other server(s) 310 included in the network. This illustrated “other server(s)” element 310 may include one or more data processing devices for performing various functions related to games conducted through system 300 and any other games that may be available to players through gaming machines 100. For example, apparatus 300 may be accounting servers providing support for cashless gaming or various forms of mixed cash/cashless gaming through the various gaming machines 100. In this example, an additional one of the other servers 310 will be included in apparatus 300 for supporting these types of wagering and payout systems. As another example, the various gaming machines 100 included in system 300 may allow players to participate in a game (primary game) other than the bank heist bonus game described herein, and this other game may rely on a result identified at or in cooperation with a device that is remote from the gaming machines. In this example, another server 310 may be included in the system for identifying results for the primary game and communicating those results to the various gaming machines 100 as necessary. Generally, the other server(s) 310 shown in FIG. 4A are shown only to indicate that numerous other components may be included along with the elements that participate in providing bank heist bonus games according to the present invention. Other server(s) 310 may provide record keeping, player tracking, accounting, result identifying services, or any other services that may be useful or necessary in a gaming system.

Referring to FIG. 4B, a block diagram of another example networked gaming system 400 associated with one or more gaming facilities is shown, including one or more networked gaming machines 100 in accordance with one or more embodiments. With reference to FIG. 4B, while a few servers have been shown separately, they may be combined or split into additional servers having additional capabilities.

As shown, networked gaming machines 100 (EGM1-EGM4) and one or more overhead displays 413 may be network connected and enable the content of one or more displays of gaming machines 100 to be mirrored or replayed on an overhead display. For example, the primary display content may be stored by the display controller or game processor 205 and transmitted through network controller 210 to the overhead display controller either substantially simultaneously or at a subsequent time according to either periodic programming executed by game processor 205 or a triggering event, such as a jackpot or large win, at a respective gaming machine 100. In the event that gaming machines 100 have cameras installed, the respective player's video images may be displayed on overhead display 413 along with the content of the player's display 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Blackberry cell phone, Apple iPhone, personal data assistant (PDA), iPad, etc.). To enter the website, a player may log in with a username (that may be associated with the player's account information stored on player account server 409 or be accessible by a casino operator to obtain player data and provide promotional offers), play various games on the website, make various personalizing selections and save the information, so that during a next gaming session at a casino establishment, the player's playing data and personalized information may be associated with the player's account and accessible at the player's selected gaming machine 100.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method for providing a wagering game for a player, the method comprising:
(a) receiving a wager from the player;
(b) receiving a play input the player;
(c) displaying a matrix of symbol locations including a plurality of symbol locations;
(d) displaying a number of symbols at selected locations in the matrix of symbol locations;
(e) after displaying a number of symbols at selected locations in the matrix of symbol locations, evaluating the matrix of symbol locations for the presence of a designated pattern of free spin symbols;
(f) in response to finding the designated pattern, awarding the player a quantity of free spins wherein the quantity of free spins is relative to the quantity of the free spin symbols in the pattern;
(g) before each of the free spins, allowing the player to select one of a series of concealed modifier elements;
(h) after the player selects a concealed modifier element, revealing the modifier element, displaying a spin result comprising a second number of symbols in the matrix of symbol locations, and applying the modifier element to the spin result;
(i) after displaying the spin result, evaluating the matrix of symbol locations for a presence of one or more winning patterns of symbols;
(j) repeating steps (g)-(i) for each free spin in the awarded quantity of free spins.

2. The method of claim 1, wherein the concealed modifier may be applied to more than one free spin in the quantity of free spins.

3. The method of claim 1, wherein the concealed modifier may consist of additional free spins.

4. The method of claim 1, wherein the player can continue to accumulate free spin symbols during the second number of symbols in the matrix of symbol locations.

5. The method of claim 1, wherein the number of free spins awarded to the player are a first designated number of free spins for a designated first pattern of free spin symbols, and a second designated number of free spins for a designated second pattern of free spin symbols.

6. A system for providing a wagering game for a player, the system comprising at least one electronic gaming machine interacting with at least one server, the system programmed for:
(a) receiving a wager from the player;
(b) receiving a play input the player;
(c) displaying a matrix of symbol locations including a plurality of symbol locations;
(d) displaying a number of symbols at selected symbols in the matrix of symbol locations;
(e) after displaying a number of symbols at selected locations in the matrix of symbol locations, evaluating the matrix of symbol locations for the presence of a designated pattern of free spin symbols;
(f) in response to finding the designated pattern, awarding the player a quantity of free spins wherein the quantity of free spins is relative to the quantity of the free spin symbols in the pattern;
(g) before each of the free spins, allowing the player to select one of a series of concealed modifier elements;
(h) after the player selects a concealed modifier element, revealing the modifier elements, displaying a spin result comprising a second number of symbols in the matrix of symbol locations, and applying the modifier element to the spin result;
(i) after displaying the spin result, evaluating the matrix of symbol locations for a presence of one or more winning patterns of symbols;
(j) repeating steps (g)-(i) for each free spin in the awarded quantity of free spins.

7. The system of claim 6, wherein the concealed modifier may be applied to more than one free spin in the quantity of free spins.

8. The system of claim 6, wherein the concealed modifier may consist of additional free spins.

9. The system of claim 6, wherein the player can continue to accumulate free spin symbols during the second number of symbols in the matrix of symbol locations.

10. The system of claim 6, wherein the number of free spins awarded to the player are a first designated number of free spins for a designated first pattern of free spin symbols, and a second designated number of free spins for a designated second pattern of free spin symbols.

11. A program product embodied in one or more tangible computer readable media, the program product including code executable by a gaming machine and at least one gaming server for:
(a) receiving a wager from the player;
(b) receiving a play input the player;
(c) displaying a matrix of symbol locations including a plurality of symbol locations;
(d) displaying a number of symbols at selected symbols in the matrix of symbol locations;
(e) after displaying a number of symbols at selected locations in the matrix of symbol locations, evaluating the matrix of symbol locations for the presence of a designated pattern of free spin symbols;
(f) in response to finding the designated pattern, awarding the player a quantity of free spins wherein the quantity of free spins is relative to the quantity of the free spin symbols in the pattern;
(g) before each of the free spins, allowing the player to select one of a series of concealed modifier elements;
(h) after the player selects a concealed modifier element, revealing the modifier elements, displaying a spin result comprising a second number of symbols in the matrix of symbol locations, and applying the modifier element to the spin result;
(i) after displaying the spin result, evaluating the matrix of symbol locations for a presence of one or more winning patterns of symbols;
(j) repeating steps (g)-(i) for each free spin in the awarded quantity of free spins.

12. The program product of claim 11, wherein the concealed modifier may be applied to more than one free spin in the quantity of free spins.

13. The program product of claim 11, wherein the concealed modifier may consist of additional free spins.

14. The program product of claim 11, wherein the player can continue to accumulate free spin symbols during the second number of symbols in the matrix of symbol locations.

15. The program product of claim 11, wherein the number of a first designated number of free spins for a designated first pattern of free spin symbols, and a second designated number of free spins for a designated second pattern of free spin symbols.
